(19) United States
(12) Patent Application Publication
(10) Pub. No.: US 2011/0253245 A1
(43) Pub. Date: Oct. 20, 2011

(54) METHOD AND APPARATUS FOR PRODUCING PIPE SECTIONS USING A LASER BEAM MOVABLE BY A SCANNING DEVICE, AND CORRESPONDING PIPE SECTION

(75) Inventor: Werner Boltshauser, Butschwil (CH)

(73) Assignee: COSMOCAN TECHNOLOGY AG, Butschwil (CH)

(21) Appl. No.: 12/998,785

(22) PCT Filed: Nov. 30, 2009
(86) PCT No.: PCT/CH2009/000382

§ 371 Date: Jul. 6, 2011

(30) Foreign Application Priority Data
Dec. 3, 2008 (CH) 1890/08

(51) Int. Cl. F16L 9/00; B23K 26/00

(52) U.S. Cl. 138/177; 219/121.72; 219/121.67

(57) ABSTRACT

When severing pipe sections from a pipe that is continuously produced, a closed separating line is formed around the section axis along the pipe circumference, the separating line being disposed by a section length from the free pipe end. In at least one embodiment, in order to sever a pipe section, a laser beam generated by a laser scanning device is deflected along the entire circumference of the pipe being produced to the separating line, always transversely to the section axis, such that a substantially focused contact region of the laser beam on the pipe being produced is guided completely along the closed separating line and, in the process, the pipe section is severed from the pipe being produced.

### PRIORITY STATEMENT

This application is the national phase under 35 U.S.C. §371 of PCT International Application No. PCT/CH2009/000382 which has an International filing date of Nov. 30, 2009, which designates the United States of America, and which claims priority on Swiss patent application number CH 1890/08 filed Dec. 3, 2008, the entire contents of each of which are hereby incorporated herein by reference.

### FIELD

Embodiments of the invention generally relate to a method and a device for producing pipe sections, and/or to pipe sections.

### BACKGROUND

When producing metal parts with a jacket that is closed in circumferential direction, a flat material band can be reshaped continuously to the closed form. For this, the two edges along both sides of a longitudinal axis are joined and are then connected to each other with a welded seam. The desired pipe sections and/or jacket sections are cut from the pipe being produced. The pipe sections can be used in the form of pipe pieces or can be processed further to form desired components.

A method is known from the document WO 2006/074570 for which the longitudinal seam is embodied as a blunt seam (V-seam) on flat material for a pipe being produced. Once the longitudinal seam is formed, the pipe being produced is expanded to have a round cross section and pipe sections are cut off. A support edge is made available on the pipe inside for the severing operation. The support edge is essentially circular in shape and closed, extends in a normal plane relative to the longitudinal axis of the pipe, and fits directly against the inside wall of the pipe. A severing tool is assigned to this support edge which is rotated along the support edge during the severing operation, so that a severing region in circumferential direction of the pipe rotates once around the pipe circumference, thereby severing a pipe section. During the severing operation, the support edge and the severing element rotate along with the wall material. Following the severing operation, the severing element is moved relative to the support edge and the pipe to a non-contact position and is moved in the direction of the longitudinal axis, counter to the movement of the pipe being produced, back to the starting position prior to the severing operation, so that it can subsequently realize another severing operation. The severing element must be moved with the correct timing in axial and radial direction. At high pipe advancing speeds, the drives required for these two movements must be moved in axial direction with high acceleration forces which requires a large expenditure.

Pipe sections which are produced with the above-described method can be used for can jackets, wherein each jacket has a longitudinal welded seam. The bottom and/or the top border are attached to the can jacket. Embodiments of can bodies are known from the document WO 2005/000498 A1 for which an upper edge sections is connected via laser welding to the can jacket.

Can bodes are understood to refer to all containers, in particular aerosol cans, beverage cans, or also tubular and vessel-type intermediate products. A fast severing method can be used particularly advantageously during the production of can jackets because this involves relatively short sections and only short severing cycles are possible at a high production speed.

It is particularly advantageous if thin sheet metal can be used for the can production since the material used for each can and thus also the costs are minimized in this way. The mechanical severing of extremely thin sheet metal is difficult because the distance between the support edge and the severing tool must be within an extremely narrow tolerance range. If the support edge is held in place from side where the pipe is being produced, meaning from the side where the pipe is not yet closed, long connecting sections which can result in positioning inaccuracies are located between the support edge and its fastening.

Is the support edge is held in place from the open end of the pipe being produced, it must be inserted from the open side, counter to the advancing direction of the jacket band, into the jacket section to be severed, and must there be moved along with the pipe in the correct position. During the severing operation, the support edge should fit against the inside of the wall material, in a position that is coordinated with the position of the severing tool. Following the severing operation, the pipe section must be removed from the support edge and/or the part with the support edge and the support edge must again be inserted into the pipe. The movements of the support edge must be realized quickly and with correspondingly high acceleration forces, so that the pipe length created when severing a section is smaller than the length of the severed section.

A quick severing is important if the pipe sections are to be used for the production of cans, for example with an output rate of 300 to 600 cans per minute. The known mechanical severing methods are expensive because relatively large masses must be accelerated and the severing cycles cannot be shortened further.

In the area of can production, severing or severing steps are known which are realized with the aid of laser beams. The document U.S. Pat. No. 4,539,463, for example, describes the severing with the aid of a laser beam of a connecting piece for a plastic container which is needed for the molding. In the process, the plastic container positioned inside a holder is rotated around its axis, so that a circumferential line is moved past the laser beam output head. The can jacket is composed of a multi-layer plastic laminate, wherein the laser beam cuts through all the layers. The described solution is suitable only for the severing of parts of an individual can. The rotating holder and the rotation during the severing operation are not suitable for severing pipe sections from a continuously produced pipe.

The document WO 2008/065063 A1 describes a device for trimming the open end of plastic cans. Several cans to be trimmed are inserted into holders mounted on a rotating table. A scanning laser is assigned to the can end to be trimmed at a rotary table position. Scanning means permit the guidance of the laser beam along a predetermined severing path. During the severing, the laser beam sweeps across a cone-shaped surface with an axis that is positioned on the axis of the can to be trimmed. The laser beam, which is directed somewhat toward the outside at the severing location, relative to the can axis, achieves a slanted severing location that is adapted to the orientation of the cone surface and which is formed without edges and/or is rounded because of the melting of the plastic material. This severing method is restricted to finished cans inserted in holders, wherein only the exposed end facing the severing device can be cut and wherein the severing surface at that location is also not oriented essentially radial, but conical with an acute angle relative to the can axis.

Various laser processing devices are known from the prior art. The document U.S. Pat. No. 6,541,732 B2 describes a laser scanning device for which the laser beam can be moved with parallel orientation along a circular path for forming a bore with cylindrical boundary. The document WO 2007/079760 A1 describes a scanning head, making available a laser axis on a robot arm which can be oriented freely in space. The document DE 10 2005 033 605 A1 describes the optics for a scanning laser with gimbal-mounted scanning mirrors that can be moved around two axes. A displaceable concave lens is provided for adjusting the focal point at a desired distance to the scanning mirror. The scanning laser is mounted on a robot arm and is thus moved to the desired working location. The document U.S. Pat. No. 6,355,907 B1 describes a laser drilling device for which a plane parallel and transparent element, transparent wedge elements and a transparent dove prism are used for moving the beam axis. Owing to the specific orientation in each case of these prism-type elements, the axis of the exiting beam, relative to the axis of the entering laser beam, can be displaced parallel and only slightly angled.

The document DE 198 44 760 A1 discloses a laser welding head for the pipe inside welding. This welding head comprises a deflection mirror, which deflects a laser beam, supplied parallel to the pipe axis, in radial direction toward the outside. For the welding on the pipe inside, the welding head is inserted into the pipe and is rotated around its axis at the desired location. Roller bearings with a pressing device ensure a constant, focused positioning. This processing head is not suitable for severing pipe sections from a pipe being produced since high acceleration forces would have to be generated for short severing cycles and the separated pipe sections could only be removed from the welding head through further extensive movements.

The scanning lasers known from the prior art would have to be moved with the aid of a robot arm around the pipe being produced to make a cut at the distance for the desired pipe, section with a laser beam oriented, if possible, radially to the pipe. The robot arrangement is extremely expensive and involved for a movement around the pipe circumference. In addition, the severing position would have to be moved along with the pipe being produced. The movements of a robot arm are not suitable for the severing of pipe sections and/or for a circular movement around the pipe.

### SUMMARY

The object of the present invention is to find a solution which allows achieving a fast and easy severing of pipe sections from a continuously produced pipe.

This object is solved with the features disclosed in claim 1 and/or 13 and/or 21. The dependent claims describe preferred and/or alternative embodiments.

When severing pipe sections from a continuously produced pipe, a closed severing line is formed around the section axis along the pipe circumference which is spaced apart by one section length from the exposed pipe end. Within the framework of the present invention, it was discovered in an inventive step that for severing the aforementioned pipe section, a laser beam supplied by a laser scanning device is guided at least once around the complete circumference of the pipe being produced and, in the process, is directed transverse to the section axis onto the severing line, wherein for the pipe being produced a substantially focused contact region of the laser beam in the severing plane that advances continuously with the pipe being produced is moved completely along the closed severing line, thereby severing the pipe section from the pipe being produced.

According to one preferred embodiment and in order to cut off a pipe section, a laser beam generated by a laser scanning device is guided at least once along the complete circumference of a first, the section axis ring-shaped enclosing optical element, wherein the laser beam is always deflected transverse to the section axis onto the severing line along the complete circumference of the first annularly closed optical element.

According to a different, preferred embodiment, at least one pivoting optical deflecting element is rotated around the section axis in the region of the severing plane that is continuously advanced along with the advancing pipe being produced, and the laser beam is deflected at least over partial regions of this rotating, optical deflection element in a direction transverse to the section axis onto the severing line. A planar mirror surface is preferably used as rotating optical deflection element. It is understood that a focusing, rotating deflection element, in particular a concave mirror surface, can also be used.

The rotating optical deflection element can be arranged inside or outside of the pipe being produced. In order to also move along the focused contact region of the laser beam in the severing plane that is continuously advanced along with the pipe being produced, the rotating optical deflection element can be moved in the direction toward the section axis, or the laser beam hitting the rotating optical deflection element changes the orientation and/or position relative to the rotating optical deflection element, such that in combination with the rotating movement of the deflection element, the desired movement of the focused contact region of the laser beam is ensured along the severing line.

Since the length of the laser beam extending from a focusing device to the severing line changes during the movement of the focused contact region of the laser beam along the severing line, the focusing device is embodied such that the focal length for all design variants always adapts to the corresponding beam length up to the severing line.

When producing pipe sections according to the invention, band-shaped flat material is advanced continuously with an advancing speed, is reshaped transverse to the band axis into a closed form, and by welding a longitudinal seam is shaped into a pipe to be produced. Pipe sections are cut off from the exposed end of the pipe, wherein a pipe section to be cut off extends over a section length along a section axis, wherein a closed severing line is formed around the section axis along the pipe circumference during the severing, wherein the severing line is located in a severing plane which is advanced continuously along with the pipe being produced and wherein this severing plane is located at a distance of one section length from the free pipe end. For the severing operation on the pipe being produced, a laser beam emitted by a laser scanning device is guided and focused such that an essentially focused contact region of the laser beam moves completely along the closed severing line, thereby severing the pipe section from the pipe being produced.

Different optics can be used for the processing of material with the aid of laser beams, wherein all of these comprise optical elements in the form of lenses and/or mirrors for focusing the laser beam. Transparent optical elements can furthermore be used for the beam guidance for which the beam direction is changed as a result of refraction on the surfaces of the elements. These elements include elements with plane-parallel surfaces such as prisms having surfaces that extend at specific angles to each other. In addition to the beam guidance and the focusing, additional problems must be solved for a successful material processing. Additional material must generally be supplied for the severing. Optical elements which heat up excessively during the material processing must be cooled down. In particular, this also applies to high-reflecting mirrors which absorb between 0.5 and 2% of the laser power. Dirt and dust are kept away from the optical elements with the aid of protective devices, in particular gas flows. If applicable, important processing parameters are monitored with sensors. The type and polarization of the laser light can be optimized for the respective use. With applications having only one processing direction, linear polarized laser light can advantageously be used, wherein the polarization direction preferably coincides with the severing direction.

During the severing with a laser, the laser beam continuously melts the material and the molten material is for the most part blown out of the severing joint by a flow of gas. Of the known severing methods, the respectively most suitable method one can be used in each case. Flame severing is a standard method used for severing steel, wherein oxygen is used as the severing gas. While nitrogen is primarily used as the severing gas during the fusion severing, argon is used for the processing of titanium. For the severing of thinner sheet metal, compressed air can also be used which is advantageous because of the lower costs. Compressed air with 5 to 6 bar pressure is sufficient to blow the molten material from the severing joint. The cost advantage over nitrogen is relative, however, because the air must be dried and de-oiled prior to being compressed. With a laser power of 5 kw and an air pressure of 6 bar, sheet metal with a thickness of 2 mm can already be cut without burrs. It is understood that the molten material can also be suctioned off in place of being blown out by arranging a suction device in the region of the severing line. The blowing out or suctioning off can furthermore also be combined. During the sublimation severing, the laser is supposed to evaporate the material if possible with little melting which can be achieved with high laser power and low severing speeds, wherein a pulsed laser is frequently used for this.

With the plasma-supported fusion severing, using CO2 lasers, a plasma cloud of ionized metal vapor and ionized severing gas forms in the severing joint. The plasma cloud causes more energy to be absorbed into the material, which allows higher severing speeds. However, the plasma cloud should not exit toward the top from the severing joint because it would then screen the laser beam from the material surface. The plasma-supported fusion severing is very advantageous for thin metal sheets because it permits using extremely high severing speeds. With a metal sheet thickness of 1 millimeter, a speed of 40 meters/minute can be achieved.

A portion of the energy of a beam impinging on the metal pipe is absorbed while another portion is reflected. The degree of absorption depends on the laser wavelength, the laser polarization, the angle of incidence of the laser beam, the pipe material, the temperature, as well as the geometry and the condition of the surface. The higher the degree of absorption, the more energy is available for the processing. The processing is also influenced by the heat conductivity of the pipe, meaning the lower the heat conductivity the easier the processing can be realized even with a lower energy. The power density corresponds to the power introduced per surface area. The power density and the exposure time determine the amount of energy per surface area that is introduced into the material to be processed. The power density can be controlled via the laser power and the focusing. The exposure time for pulsed lasers can be adapted via the pulse duration and, in the moving state, via the advancing speed. Power densities starting at 10 kW/mm2 and exposure times in the range of milliseconds can be used for the severing.

To obtain the most efficient laser severing possible, the laser beam should hit the surface to be worked on in such a way that the power required for the severing is absorbed. For this, it must be taken into consideration that the depth of the focus sharpness influences the severing operation in addition to the focus. The sharpness depth defines an expansion in the direction of the laser axis within which the beam cross section is expanded to twice the focal surface. If a beam arrives at a flat angle on the material to be processed, the focus depth, if applicable, does not extend far enough into the material to realize a cut through the material.

When severing pipe sections, a closed severing line is formed around the section axis along the pipe circumference, wherein the severing line preferably is located in a severing plane that is arranged perpendicular to the section axis and is advanced continuously along with the pipe being produced. When processing a pipe with circular cross section, it is advantageous if the laser beam is directed toward the pipe axis, at an angle of less than 45°, preferably less than 30° and especially less than 15°, between the severing plane and the axis of the beam segment impinging on the pipe.

For embodiments having an annular, closed optical element and a pipe with circular cross section, it is advantageous if the first annular, closed optical element extends circular around the section axis and has a surface that extends in longitudinal planes through the section axis, at an angle to the section axis, in particular a conical or concave surface, and if the laser scanning device is essentially aimed in the direction of the section axis toward the pipe being produced, wherein the focusing effect of the first annular, closed optical element and the focus of the beam reaching the first optical element ensures the required focusing of the contact region for the severing operation.

To minimize the movement of masses, the laser scanning device is arranged locally fixed and during the severing operation, the orientation of the laser beam toward the continuously advancing severing line is achieved by changing the position of the laser beam toward its section directly in front of the annular closed optical element, relative to the section axis, during the movement of the laser beam along the circumference of the first annular, closed optical element. The position of the laser beam is calibrated to the deflection characteristic of the first optical element, which depends on the position of the radially impinging laser beam on the first annular, closed optical element, to the location where it impinges along the circumference of the first annular, closed optical element and to the advancing speed of the pipe being produced. It means that during the movement along the circumference of the first optical element, the beam is additionally also moved in radial direction, such that the point of intersection in axial direction moves along with the advancing speed of the pipe being produced. It is furthermore continuously ensured that the focusing is adjusted to the location along the severing line where the laser impinges. For this, the laser scanning device is provided with at least one movable mirror and, in particular, an adjustable focusing element.

To achieve a precise guidance of the laser beam and an optimum focus, if possible, at the severing location, it is advantageous if the first annular, closed optical element is arranged around the pipe being produced and the laser beam is consequently directed toward the severing line from the outside of the pipe being produced. The position of the first optical element must always be maintained precisely during the operation, so that the severing line is realized correctly. This precise position can be ensured easier if the first optical element is arranged on the outside of the pipe than if the first optical element is arranged on the inside of the pipe since it would then have to be held in place over a long distance from the feed side of the band material. A further advantage of having a first optical element arranged on the outside is that owing to the deflection of the laser beam in a direction having a share that extends radially toward the inside, the beam in its expansion is somewhat focused tangential to the severing line. With a first optical element arranged on the inside of the pipe, the deflection toward the outside would result in a slight de-focusing, meaning the supplied beam would have to be focused stronger in order to achieve the desired focusing at the pipe. If no optical element is arranged on the pipe inside, the space remains clear for a removal device, used for removing the cut-off pipe sections. A removal device of this type can hold the pipe section during the severing operation and, if applicable, can ensure that the pipe section is admitted with a force in the direction of the pipe advancement. Once the severing is completed, the removal device can ensure with a tilting movement that the pipe section is removed without coming in contact with the first optical element arranged on the outside.

A particularly easy way to move the laser severing point along in axial direction with the pipe movement can be achieved if the laser scanning device comprises an optical element that deflects toward the outside, transverse to the section axis, and which is positioned rotating around the section axis and directs the laser beam onto the first annular, closed optical element at an adjustable distance to the section axis and essentially parallel to the section axis. A displacement parallel to section axis of a laser beam component that is focused onto the first optical element achieves a desired movement of the laser beam which impinges on the pipe being produced, thus making it possible to easily move the laser beam impinging on the pipe along with the movement of the pipe being produced.

The optical element which deflects toward the outside is embodied, for example, as laser refractory element with two plane parallel surfaces. If this preferably cylindrical element is then guided away from the section axis under an adjustable angle, a laser beam oriented along the section axis can enter through one of the plane parallel surfaces into the deflecting optical element and can exit again through the other plane parallel surface, at a distance to the section axis. In the process, the exiting beam is continued parallel to the entering beam. The distance between these two beam segments depends on the distance between the two plane parallel surfaces of the deflecting optical element and the angle between the section axis and the plane parallel surfaces. It is understood that the deflecting optical element, for example, can also be formed with two cooperating prisms with adjustable spacing.

A further option for easily moving the laser severing point in axial direction along with the pipe movement can be achieved if an additional annular, closed optical element is used and a laser beam generated by the laser scanning device is guided at least once along the complete circumference of the first and the additional annular, closed optical element, wherein the beam is guided over the additional annular, closed optical element to the first annular, closed optical element.

When using an additional annular optical element, the configuration of the first and the additional optical element is particularly simple if the beam travels from the laser scanning device essentially perpendicular to the section axis in radial direction toward the outside and to the additional optical element. It would be possible for a laser beam rotating around the section axis to be deflected by a static, rotation-symmetrical element to another optical element, wherein the laser beam in that case would be somewhat out of focus, at least in the beam expansion perpendicular to the section axis, as a result of a convex share of the convex deflection surface.

To avoid an undesirable defocusing, an optical element that is flat or, if applicable, concave is used which rotates around the section axis and deflects radially toward the outside. This rotating element can be embodied with a mirror or, if applicable, with at least one prism, for example a pentaprism. The laser beam is directed coaxial to the section axis toward the optical element which deflects radially to the outside. The first and the additional annular, closed optical element are each preferably embodied as conical mirrors, having opening angles of 45°. As a result, a laser beam extending perpendicular to the section axis, which impinges in radial outward direction onto the additional optical element, is guided parallel to the section axis onto the first optical element. With the first optical element, the laser beam is directed radially toward the inside onto the pipe being produced. A desired movement of the laser beam that radially impinges on the pipe being produced is achieved by displacing the radially outward directed laser beam in the direction of the section axis, thereby making possible a simple movement of the laser beam impinging on the pipe along with the movement of the pipe being produced. To make possible this accompanying movement, the rotating optical element of the laser scanning device is also embodied so as to be displaceable along the section axis.

If the laser beam did not arrive parallel to the section axis on the first optical element, the moving along of the laser severing point in axial direction with the pipe movement can also be achieved with a movement of the first optical element. The laser scanning device can be arranged locally fixed. During the severing operation, the focusing of the laser beam onto the continuously advancing severing line can be achieved in that the first annular, closed optical element is moved along with the pipe being produced during the separation. If applicable, the orientation of the laser beam must additionally be adapted.

Focusing elements known from the prior art, such as lenses and concave mirrors, can be arranged at different locations and can be embodied differently for the focusing. Since the first annular, closed optical element, during the deflection of the laser beam in one direction with a share radially toward the inside, focuses the beam somewhat in its expansion tangential to the severing line, a annular focusing element is used, if applicable, which also focuses the beam the same way in planes with the section axis (meaning perpendicular to the tangential focusing). If the first optical element is a mirror, then the focusing in planes with the section axis can be ensured through a corresponding curvature of the mirror in sections with these planes.

If applicable, however, at least a share of the focusing is achieved in the planes with the section axis by using an annular lens which is preferably arranged between the first optical element and the pipe. Since the focusing tangential to the severing line, which can be achieved with the first optical element, is not directed toward the pipe surface but toward the section axis, the laser beam exiting the laser scanning device should preferably already be somewhat focused to ensure a focusing onto the pipe surface at the end of the beam guidance.

It is understood that in order to guide the laser beam, all optical elements known from the prior art can be used in addition to the annular, closed optical element around the section axis.

The present invention is not limited to the severing of pipe sections of a pipe with circular cross section. If the pipe has a different cross section, for example an oval or if applicable an essentially rectangular cross section, the first optical element arranged around the section axis is embodied correspondingly and the guidance of the laser beam is adapted to its geometry. It is an essential advantage of the new and inventive solution that pipes with optional cross sections can now be processed. When changing from one cross-sectional size and shape to another one, at least the first optical element must be replaced. In addition, the control of the laser scanning device must be adapted. With solutions using an additional annular optical element and/or an optical element that deflects transverse to the section axis toward the outside and/or an annular focusing element, at least one of these elements must be replaced if applicable.

The solution according to the invention for severing pipe sections from a pipe that is produced continuously with a longitudinal welded seam can be used particularly advantageous for the production of can jackets since the wall thickness of these jackets is thin enough so that the laser severing is particularly efficient. If the band material is provided with a decorative film and/or an inside film, the film can be cut together with the stabilizing portion of the pipe and/or the jacket band when severing the jacket sections.

If a laser beam emitted by a laser scanning device is guided along the circumference of an annular, closed optical element that is arranged around the section axis and, in the process, is deflected transverse to the section axis onto the severing line, only the region onto which the laser beam impinges is needed in all cases for the reflection. It is therefore possible to use an optical deflection element with considerably smaller deflection area, wherein this smaller deflection area must be rotated in such a way around the section axis that the laser beam always impinges on the rotating deflection area. The smaller element can be embodied such that the laser beam retains a rotation-symmetrical focusing during the deflection. Flat or if applicable concave, beam-centered mirrors are preferably used for this.

According to a different preferred design variant, at least one pivoting and rotation-symmetrical deflecting optical element is rotated around the section axis in the region where the severing plane is continuously advanced along with the pipe being produced and the laser beam is deflected at least over partial regions of this rotating optical deflection element in a direction transverse to the severing line.

To maintain with the pipe being produced the essentially focused contact region of the laser beam in the severing plane, which continuously advances along with the pipe being produced, the rotating optical deflection element can be moved in the direction of the section axis. To omit the movement in the direction of the section axis, the deflection surface of the rotating optical deflection element radial to the section axis can be embodied large enough, so that the movement of the focused contact region of the laser beam along with the severing plane can be achieved through a movement of the laser beam on the deflection surface of the rotating optical deflection element, with a radial movement share relative to the section axis. The complete movement of the laser beam impinging on the deflection surface is composed of a movement share around the section axis and a movement share radially to the section axis.

While the pipe is being produced, the inventive design variants make it possible to move along the focused contact region of the laser beam in the severing plane which advances continuously along with the pipe being produced, as well as the rotation of the focused contact region around the pipe. If parts of the severing device used for this must be accelerated, these are embodied with the lowest possible mass to keep the acceleration forces low. In circumferential direction, an acceleration of the mass can be omitted if the at least one optical element, which deflects the laser beam supplied by a laser scanning device transverse to the section axis onto the severing line, is used immovably or rotating with a constant rotational speed around the section axis. The minimum acceleration forces can be obtained particularly easily if the laser beam of the laser scanning device is supplied from the open, leading front of the pipe being produced, preferably coaxial or at an acute angle to the section axis. With this axial arrangement, the laser scanning device need not be moved in the direction of the section axis. In the region between the severing plane and the open front of the cut-off pipe section, a clearance space radially to the section axis is provided at least intermittently and at least in one direction through which the pipe section can be removed.

### BRIEF DESCRIPTION OF THE DRAWINGS

The drawings explain the solution according to the invention with the aid of three exemplary embodiments, which show in:

FIG. 1A perspective representation of the pipe during the expanding and severing of pipe sections;

FIG. 2 A view from the front of the pipe during the closing, welding and expanding;

FIG. 3 A perspective view of an expanding element for expanding the pipe;

FIG. 4a A schematic longitudinal section through the laser severing device with a concave first annular optical element;

FIG. 4b A schematic longitudinal section through the laser severing device with a convex first annular optical element;

FIG. 5 A schematic longitudinal section through the laser severing device with a concave first annular optical element and a deflecting element which can be pivot and swiveled and deflects toward the outside;

FIG. 6 A schematic longitudinal section through the laser severing device with two annular conical mirrors and one mirror that can rotate around the section axis and can be displaced along the section axis;

FIG. 7 A schematic longitudinal section through a laser severing device with three flat mirrors that rotate around the section axis, of which one mirror can be displaced along the section axis;

FIG. 8 A schematic longitudinal section through a laser severing device with three flat mirrors that can rotate around the section axis, wherein all these mirrors can be displaced along the section axis, and

FIG. 9 A schematic longitudinal section through a laser severing device with a planar mirror inside the pipe which can rotate around the section axis.

### DETAILED DESCRIPTION OF THE EXAMPLE EMBODIMENTS

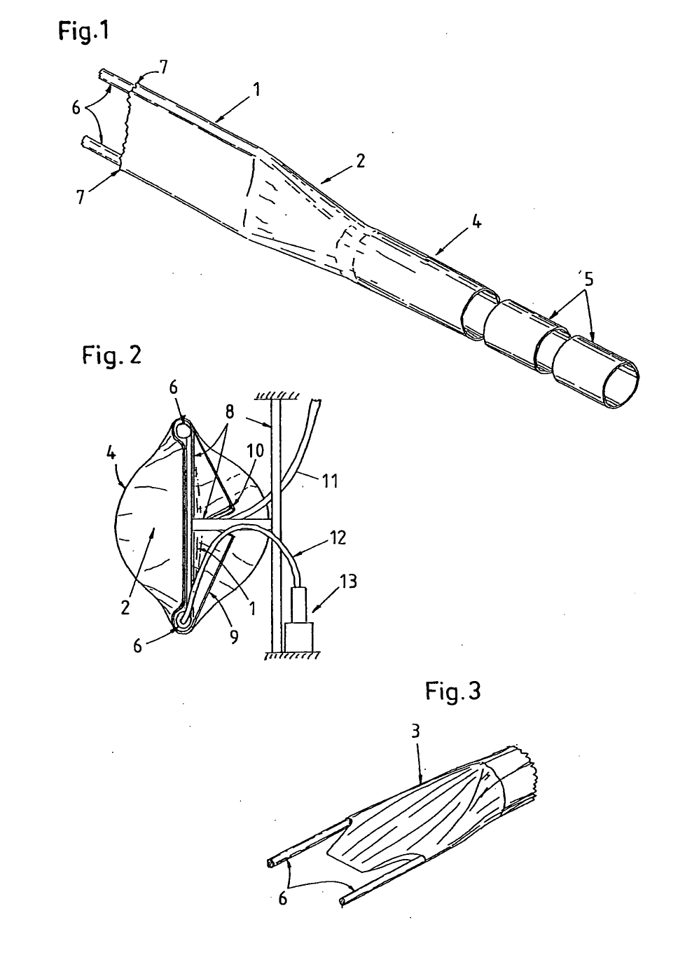

FIGS. 1 to 6 describe solutions for the severing of pipe sections which are particularly advantageous for providing can jackets for the can production. These solutions permit severing short pipe sections from a pipe being produced during short severing cycles.

FIGS. 1 to 3 schematically show how a flat compressed, closed metal band 1 is reshaped in an expansion region 2 with the aid of an expansion element 3, arranged on the inside of the closed metal band, into a pipe 4 with essentially circular cross section. Pipe sections 5 are then cut from the pipe 4 that is being produced.

The expansion element 3 is held in place by holding rods 6 which are arranged in the two bending regions 7 of the flat-pressed metal band 1 and, according to FIG. 2, extend from the expansion element 3 to a holder 8 in a region in which the band-shaped flat material 9 is not yet closed. It has turned out to be advantageous for the further processing if the bending radius for the bending regions 7 is selected larger than shown in the drawing, so that the flat region in the center extends over a shorter cross-sectional expansion than the two bending regions 7 together. It is advantageous if all cross-sectional curvatures have the largest possible bending radii.

If necessary, a sealing bead 10 is arranged on the flat material 9. The flat material is reshaped with the aid of the non-depicted rollers into the flattened, closed form and is welded with the aid of a laser beam supplied by a laser 11. If applicable, the sealing bead 10 is subsequently attached with the aid of a melting operation to the inside of the longitudinal seam. The pipe 4 is then moved to the expansion area 2 where it is finally given the circular cross section.

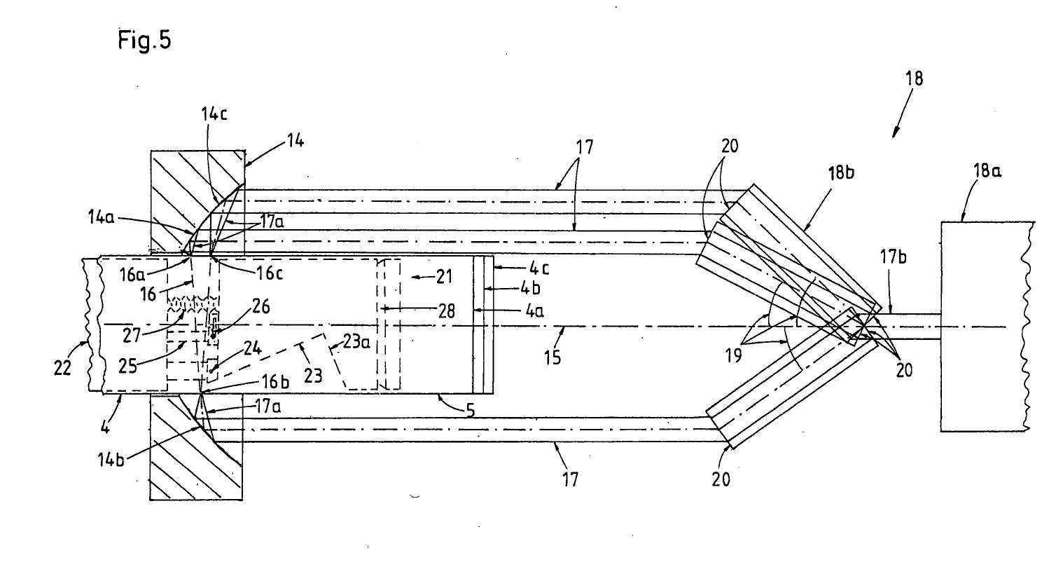

Feed lines 12 can be arranged in the two bending regions 7. A feed line 12 through a holding rod 6 is shown in the exemplary embodiment. The feed lines 12 are used, for example, for activating a removal device that is described with the aid of FIG. 5 and is used for removing the severed pipe sections 5. If applicable, gas for the laser severing operation can also be supplied through such a feed line 12 to the pipe inside. A corresponding drive unit is provided for a hydraulic or pneumatic activation of the removal device.

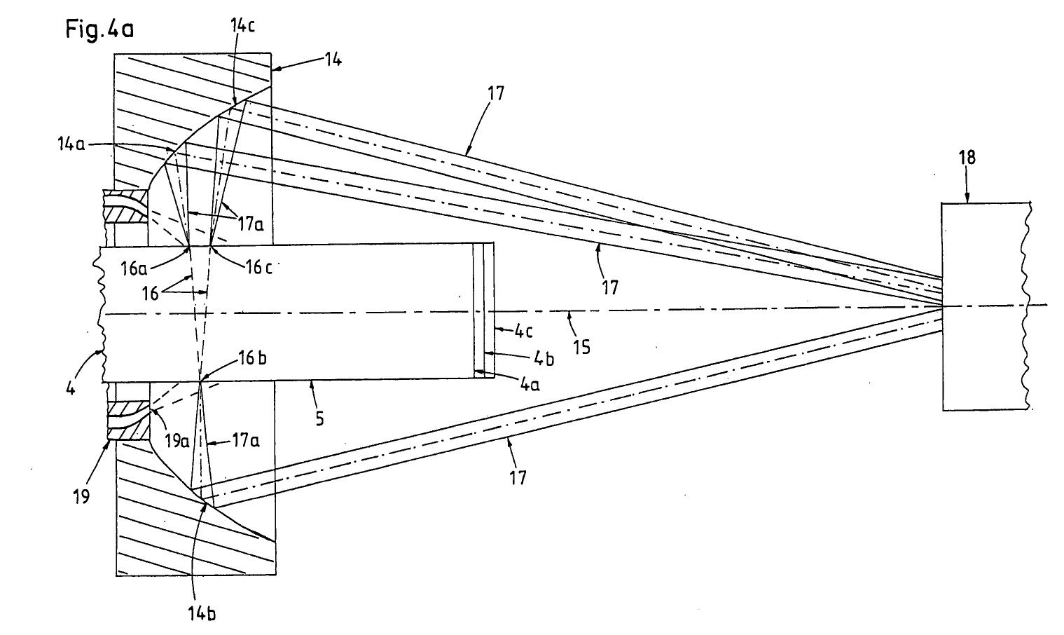

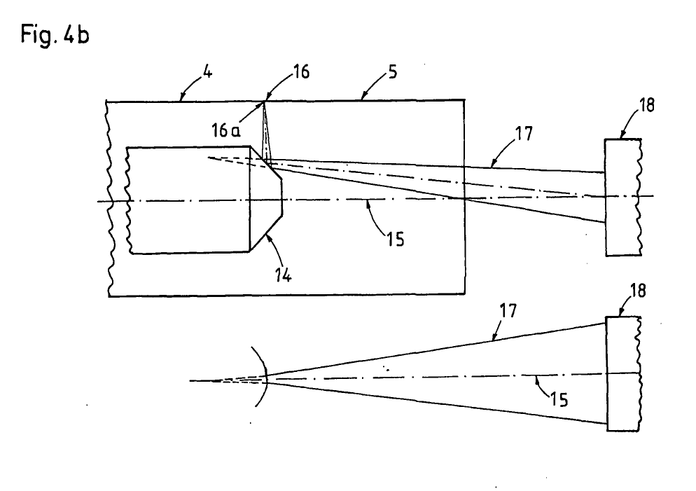

FIG. 4a shows an embodiment of the laser severing device with a first annular, closed optical element 14 in the form of a mirror having a concave-shaped reflecting surface in the severing plane shown herein. The first optical element 14 is arranged at the location of the severing line 16 around the pipe section 5 to be severed. It is understood that embodiments are also possible for which the reflecting surface has a conical shape, wherein an adapted beam guidance as well as an adapted focusing must be selected in that case. In place of a reflecting surface, the first optical element could also be embodied as total-reflection prism, for example in the form of an annular pentaprism, with curved entrance and exit surfaces in the severing planes which comprise the section axis. Even a combination of annular mirrors, prisms and lenses would be possible.

The severing line 16 is shown at an angle to the section axis 15 in the Figure because it is shown as a representation of the development of the severing line on the advancing pipe 4. Correspondingly, the exposed front 4a, 4b, and 4c of the pipe 4 is shown in three positions, namely at the start 4a, the center 4b and the end 4c of the severing operation.

A laser scanning device 18 is essentially oriented in the direction of the section axis 15 toward the pipe 4 being produced and can direct a laser beam 17 along the complete circumference of the first optical element 14 onto this element. At the start of the severing operation, the focal region of a segment 17a of the laser beam 17, which is directed toward the pipe 4, is located at the starting location 16a of the severing line 16. The laser beam 17 is directed by the laser scanning device 18 toward a starting region 14a of the first annular, closed optical element 14. The starting region 14a is oriented such and is concave curved in such a way that following the deflection at the first optical element 14, the laser beam 17 impinges with the desired focusing onto the starting location 16a of the severing line 16. The laser beams 17 is moved around the section axis 15 by the laser scanning device 18, wherein the angle between the section axis and the axis of the laser beam 17 is increased continuously.

In the middle of the severing operation, the focal region of the segment 17a of the laser beam 17 which is directed toward the pipe 4 is located at the center location 16b of the severing line 16, wherein the laser beam 17 is deflected at a center region 14b of the annular, closed optical element 14. At the end of the severing operation, the focus region of the segment 17a of the laser beam 17 which is directed toward the pipe 4 is located at the end location 16c of the severing line 16, wherein the laser beam 17 is deflected at an end region 14c of the first annular, closed optical element 14.

In the schematic representation, the laser beam 17 emitted by the laser scanning device 18 is shown as a beam with parallel beam edges. It is understood that the laser beam 17 is preferably already is somewhat focused, at least in the expansion tangential to the severing line 16, so as to ensure the desired focusing at the severing line 16. Since the length of the beam segments 17 and 17a along the severing line 16 changes, the focusing is preferably also adapted continuously during the severing operation. The curvature of the concave mirror surface of the first optical element 14, shown in FIG. 4, illustrates that the curvature resembles a parabolic. The stronger curvature in the regions closer to the pipe make it possible to obtain the desired focusing, even with differently oriented laser beams 17, as well as to achieve a steep orientation for the sections 17a which are directed toward the pipe 4.

The focusing effect of the first annular, closed optical element 14 and the shape of the focus of the laser beam arriving at the first optical element 14 ensure the necessary focus of the contact region for the severing along the severing line 16. The severing line 16 is in the severing plane. An angle is formed between the severing plane and the axis of the beam segment 17a which impinges on the pipe, which is smaller than 45° along the total severing line, preferably smaller than 30° and in particular smaller than 15°.

The first optical element is preferably cooled because heat is generated during the deflection of the laser beam on the first optical element 14 as a result of the absorbed energy share.

To be able to blow the material and/or the molten parts generated during the laser severing with a gas stream out of the severing joint, an annular gas supply line 19 is assigned to the first optical element. If applicable, the desired severing gas which may be compressed air flows from the gas supply line 19 through a correspondingly formed exit opening 19a to the severing line 16. A vacuum pressure is generated, if applicable, inside the pipe section 5 to make it easier to remove the molten material.

It is understood that in place of changing the angle between the laser beam 17 and the section axis 15, the first optical element 14 can also be displaced in the direction of the section axis 15 to ensure a movement along with the advancing pipe.

FIG. 4 shows an embodiment for which the first annular, closed optical element 14 is a conical mirror surface located inside of the pipe 4. A severing plane is shown in the upper area of FIG. 4b which comprises the section axis 15. In this severing plane, the laser beam 17 is deflected as a result of the reflection at the conical mirror surface, but only to the starting location 16a of the severing line 16. The focusing of the laser beam 17 in this severing plane is selected such that the laser beam is focused onto the starting location 16a. If applicable, a vacuum pressure is generated in the area of the severing line with the aid of a suction device that is fitted in the manner of a collar around the pipe section 5, so that the molten material can be removed easier.

The lower portion of FIG. 4b shows the focusing of the laser beam perpendicular to the aforementioned severing plane and/or tangential to the conical mirror surface. Owing to the fact that the conical mirror surface for this beam expansion deflects so as to be de-focusing, the laser beam 17 that is supplied must be focused stronger for this beam expansion, so that the focus for this beam expansion is also located at the starting location 16a of the severing line 16 following the deflection.

In addition to the beam guidance along the annular mirror surface, the laser scanning device 18 must therefore make available a beam shape with differing beam width and focusing in the two main directions of the beam cross section, wherein the main directions must rotate along during the rotation of the beam, so that the larger expansion when the laser beam 17 impinges on the conical mirror surface is always oriented tangential to this surface. It is understood that the mirror surface in the severing plane could also be embodied convex or concave, wherein the shape of the laser beam 17 would then have to be selected accordingly.

FIG. 5 shows an embodiment for which the laser beam 17 is directed essentially parallel to the section axis 15, with an adjustable distance to the section axis 15, toward the first annular, closed optical element 14. A parallel displacement, relative to the section axis 15, of the laser beam 17 that is directed toward the first optical element 14 causes a desired movement of the laser beam segment 17a impinging on the pipe being produced, thus making it easier to move it along with the movement of the advancing pipe. To be able to guide the laser beam 17 parallel to the section axis 15, the laser scanning device 18 comprises a laser source 18a and an optical element 18b which deflects transverse to the section axis toward the outside, wherein this optical element is positioned so as to rotate around the section axis 15 and can adjust the distance between the laser beam 17 and the section axis.

The optical element 18b that deflects toward the outside is embodied, for example, as laser-refractive element with two plane parallel surfaces 20. If this element guides away from the section axis under an adjustable angle 19, then a laser beam segment 17b that is supplied along the section axis 15 can enter the deflecting optical element 18b through one of the plane parallel surfaces 20 and, at a distance to the section axis 15, can exit again through the other plane parallel surface 20. In the process, the exiting laser beam 17 is conducted further parallel to the entering laser beam segment 17b. The distance between these two laser segments depends on the distance between the two plane parallel surfaces 20 of the deflecting optical element 18b and the angle 19 between the section axis 15 and the plane parallel surfaces 20. It is understood that the deflecting optical element 18b can also consist of two cooperating prisms arranged at an adjustable distance to each other, wherein the adjustment of the distance between the two prisms takes the place of the adjustment of the angle 19.

Since the laser beam 17 is always oriented parallel to the section axis 15 when it impinges on the first optical element 14, the deflecting mirror surface can be embodied similar to a spherical surface, so that the focusing effect of the mirror surface in the laser beam cross section is essentially the same in all directions.

A removal device 21 for removing cut-off pipe sections 5 is arranged on the pipe 4 inside. A removal device 21 of this type can hold the pipe section 5 during the severing operation and, once the severing is completed, can ensure with the aid of a tilting movement that the pipe section is removed without making contact with first optical element 14 arranged on the outside. The removal device 21 for the embodiment shown herein is arranged on a mandrel 22 of the pipe-forming device and comprises a holding part 23, a pivoting connection 24, as well as an activation element 25. The activation element is embodied as a piston, movable in the direction of the section axis 15, which is attached to a guide 26 of the holding part 23, so as to achieve the desired tilting movement of the holding part 23 together with the pivoting connection.

A flexible compressed air feed 27 and in the holding part 23 an annular exit nozzle 28 are provided for admitting the pipe section 5 with a force in the direction of the pipe advancing movement. The air exiting through the exit nozzle 28 admits the pipe section 5 with a force in advancing direction which can be used advantageously at the end of the severing line and during the removal of the pipe section 5. For the removal in a controlled manner, the holding part 23 is tilted downward with its free end. So that the pipe 4 being produced does not come in contact anywhere with the tilted holding part 23, a recess 23a is provided in the holding part 23.

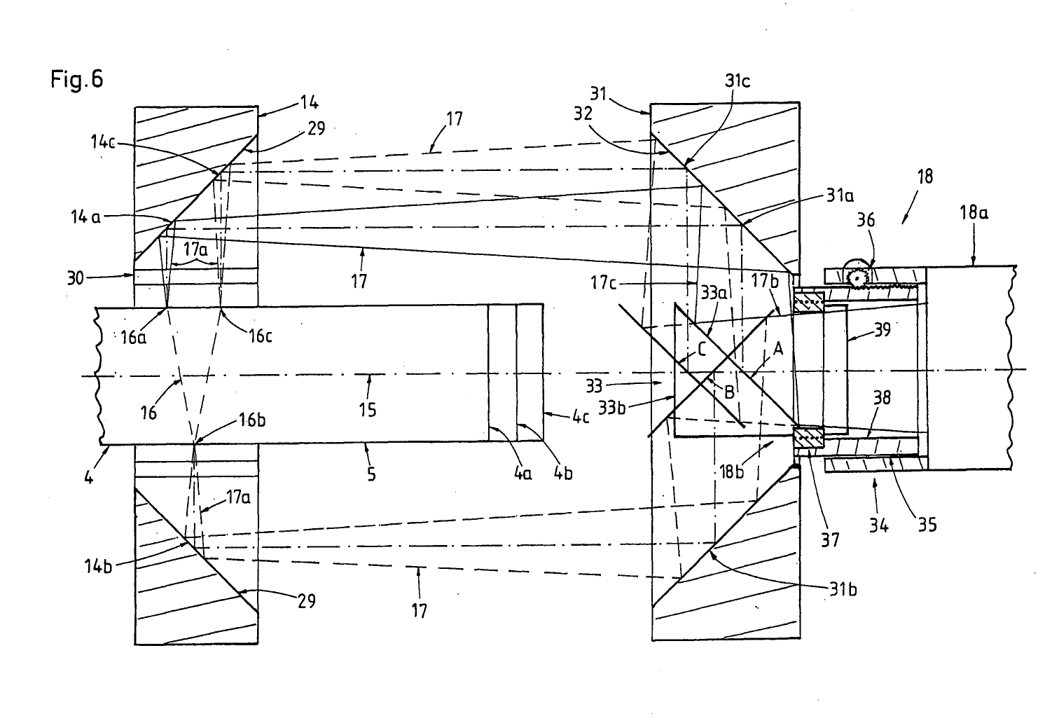

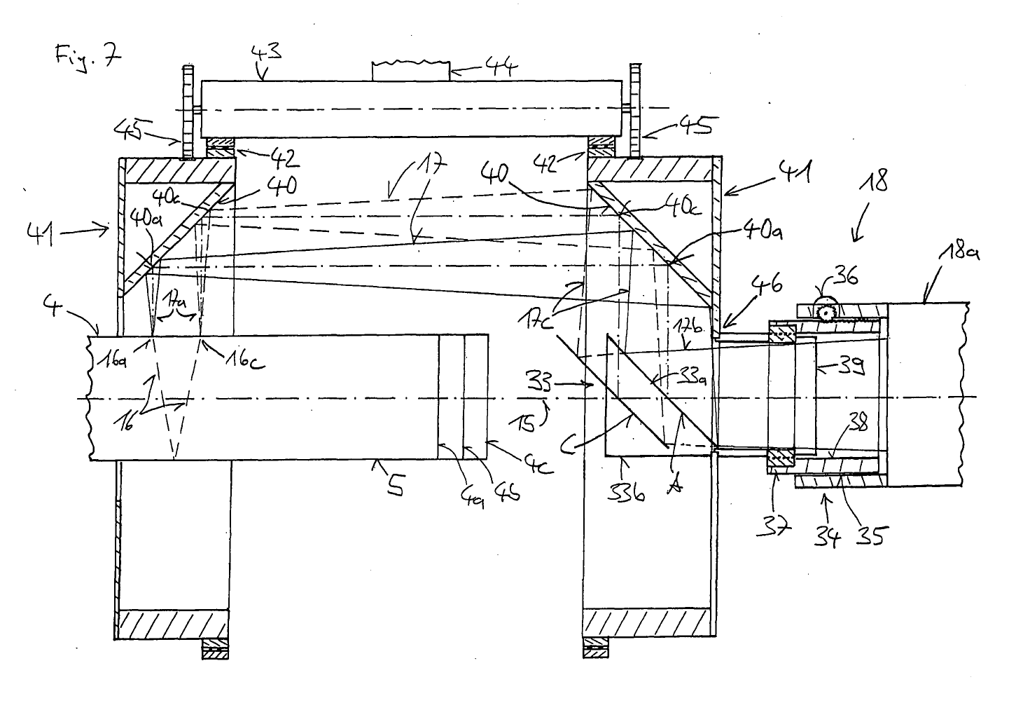

FIG. 6 shows an embodiment for which the first optical element 14 comprises a conical mirror surface 29. Since the deflection at the first optical element 14 in planes with the section axis 15 does not have a focusing effect, a laser beam is used which is already focused in these planes, wherein this is illustrated with the converging side edges of the beams. With a schematically shown lens element 30, an additional focusing can be achieved in the planes with the section axis 15 which is preferably selected tangential to the severing line corresponding to the focusing. Thus, if the focusing based on the conical mirror surface 29 and the lens element 30, which deflect radially toward the inside, is essentially the same, a rotation-symmetrical laser beam 17 can be deflected to form a rotation-symmetrical laser beam segment 17a.

The laser beam 17 which is oriented parallel to the section axis 15 arrives emanates from a different annular, closed optical element 31 which preferably comprises a conical mirror surface 32. If the opening angle of the two mirror surfaces 29 and 32, relative to the section axis 15, are essentially 45° and the mirror surfaces 29 and 32 are aligned with one another, then an axial displacement of the laser beam segment 17a that impinges radially onto the pipe can be achieved with a beam segment 17c which is displaceable in the direction of the section axis 15 and is directed radially toward the additional optical element 31. In place of the conical mirror surfaces 29 and 32, total reflection, annular, closed prisms, for example in the form of an annular pentaprism, can also be used if necessary, wherein the entrance surface and the exit surface in the severing planes with the section axis 15 would be arranged at an angle of 90° relative to each other.

To generate the laser beam segment 17c which is conducted radially toward the outside and rotates around the section axis, the laser scanning device 18 comprises a flat or, if applicable, a concave optical element 33 that rotates around the section axis 15 and deflects radially toward the outside. This rotating, radially toward the outside deflecting optical element 33 can be embodied with a mirror or, if applicable, at least one prism such as a pentaprism. A laser beam segment 17b extends from the laser source 18a along the section axis 15 to the radially deflecting optical element 33.

To position the radially deflecting optical element 33 such that it rotates around the section axis 15 and such that it can be displaced in the direction of the section axis 15, the laser scanning device comprises an advancing device 34 with a guide 35 as well as a drive 36. During the severing operation, the distance advanced with the aid of the advancing device 34 must be coordinated precisely with the advancing movement of the pipe 4. A rotary device 37 with bearing and drive is installed between the advancing part 38 and the radially deflecting optical element 33. For the embodiment shown herein, the radially deflecting optical element 33 comprises a mirror 33a and a mirror holder 33b which is connected to the rotating part of the rotary device 37.

The supplied laser beam 17b is beamed onto continuously rotating mirror 33a during precisely one rotation of this mirror. At the start of the rotation, the mirror 33a is in the position A and the laser beam is guided via the deflection regions 31a and 14a of the two annular optical elements 31 and 14 to the starting location 16a on the severing line 16. In the middle of the severing operation, the mirror 33a is in the position B and the laser beam is guided via the deflection regions 31b and 14b of the two annular optical elements 31 and 14 to the center location 16b on the severing line 16. At the end of the severing operation, the mirror 33a is in the position C and the laser beam is guided via the deflection regions 31c and 14c of the two annular optical elements 31 and 14 to the end location 16c on the severing line 16.

The deflection of the laser beam 17c in radial outward direction on the additional annular optical element 31 during the expansion of the beam, tangential to the circumference of the additional annular optical element 31, occurs essentially parallel or with little de-focusing only if the radial beam segment has the shape of an expanded beam emanating from the section axis. Correspondingly, the beam on a flat mirror 33a should have a narrow shape, perpendicular to the shown severing plane, wherein this shape widens with increasing distance to the section axis 15. To obtain a respective beam shape on the mirror 33a, a beam-forming optical element 39, for example a special lens arrangement, is attached together with the mirror 33a to the rotating part of the rotary device 37. Since the two annular optical elements 14 and 31 are configured symmetrical, it is easiest if the tangential focus of the beam in the region of the mirror 33a corresponds to the desired focus in the region of the severing line. The desired shape for the radial beam segment can also be obtained, if necessary, by embodying the mirror 33 not flat, but with a concave and convex region, meaning convex above the section axis and concave below it.

FIG. 7 shows an embodiment for which at least one optical deflection element 40, positioned rotating, is rotated around the section axis 15 in the region of the severing plane that advances continuously with the pipe 4 being produced and if the laser beam 17 is deflected over partial regions of this rotating optical deflection element 40 transverse to the section axis 15 and onto the severing line 16. The rotating optical deflection element 40 is preferably embodied as a flat mirror surface, if applicable as a prism such as a pentaprism, and is arranged on a rotary device 41. The rotary device 41 is connected via a rotary bearing 42 and a driving device 43 with a frame portion 44. The driving device 43 drives the rotary device 41 with the aid of a motion transmission 45. At the start of the severing operation, the focusing region of a segment 17a of the laser beam 17 that is directed toward the pipe 4 is located at the starting location 16a on the severing line 16 and at the end of the severing operation it is located at the end location 16c.

The laser scanning device 18 generates a laser beam segment 17c that extends radially toward the outside and rotates around the section axis 15 and, to do so, comprises a deflecting optical element 33 that rotates around the section axis 15 and deflects radially toward the outside. This rotating, radially toward the outside deflecting optical element 33 can be embodied with a mirror or, if applicable, with at least one prism, for example a pentaprism. A laser beam segment 17b extends from the laser source 18a along the section axis 15 to the radially deflecting optical element 33.

To position the radially deflecting optical element 33 so as to rotate around the section axis 15 and such that it can be displaced in the direction of the section axis 15, the laser scanning device comprises an advancing device 34 with a guide 35 and a drive 36. During the severing, the advancing movement of the advancing device 34 must be synchronized precisely with the advancing movement of the pipe 4. A rotary device 37 is installed between the advancing part 38 and the radially deflecting optical element 33. For the embodiment shown, the radially deflecting optical element 33 comprises a mirror 33a and a mirror holder 33b which is connected to the rotating portion of the rotary device 37.

An additional, rotating optical element 40 is arranged in radial direction outside of the rotating, outward deflecting optical element 33, wherein the laser beam segment 17c is deflected at the severing plane over partial regions of this additional rotating optical element 40, parallel to the section axis 15, to the rotating optical deflection element 40. The additional rotating optical deflection element 40 is also arranged on an additional rotary device 41, which is connected via an additional rotary bearing 42 and the drive device 43 to the frame part 44. The drive device 43 drives the rotary device 41 via the motion transmission 45. The two optical deflection elements 40, positioned rotating, are rotated synchronously around the section axis.

A rotary coupling 46 transfers the rotation of the additional rotary device 41 to the radially deflecting optical element 33 and/or to the mirror holder 33b. So that the radially deflecting optical element 33 can still be moved in the direction of the section axis 15, the rotary coupling 46 is ensured, for example, via a displaceable intervention device that is form-locking in circumferential direction but can be moved in axial direction. The two rotary devices 41 are arranged immovably in the direction of the section axis. As a result, only acceleration forces for the axial movement of the radially deflecting optical element 33 are required. Since this can be constructed lightweight, they are very low forces. The rotating parts are rotated with a constant speed.

The supplied laser beam 17b is beamed precisely during one rotation onto the continuously rotating mirror 33a. At the start of this rotation, the mirror 33a is in the position A and the laser beam 17 is guided over the deflection regions 40a of the two rotating optical deflection elements 40 to the starting location 16a on the severing line 16. At the end of the severing operation, the mirror 33a is in the position C and the laser beam 17 is guided over the deflection regions 40c to the end location 16c on the severing line 16.

For the embodiment shown, the beam is already focused when exiting the laser source 18a, which is connected to an undesirably large focal length. It is understood that a focusing device 48, drawn in for the rotary device 37, can also be arranged on one of the rotary devices 41 or on the mirror holder 33b arranged in the laser beam path and that the laser beam between the laser source 18a and the focusing lens has the shape of a parallel beam in that case in that case. The focusing device 48 respectively adjusts the beam focus, required at the severing line 16, to match the changing length of the laser beam 17 extending from the focusing device to the severing line.

The exposed fronts 4a, 4b and 4c of the pipe 4 being produced are shown in three positions, namely at the start 4a, in the center 4b and at the end 4c of the severing operation. Once the pipe section 5 is severed completely, it can be removed in downward direction between the two rotary devices 41.

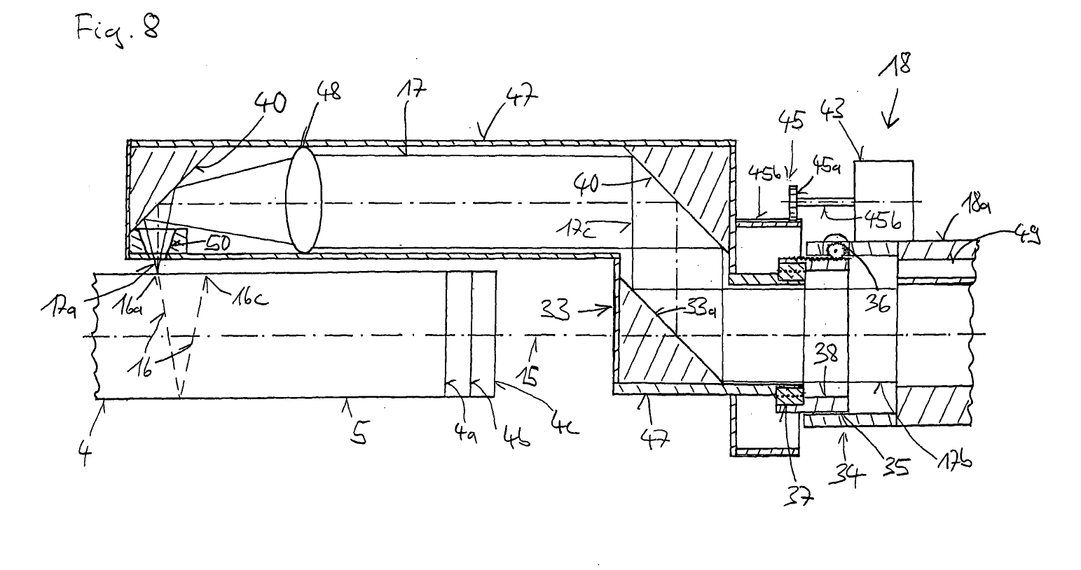

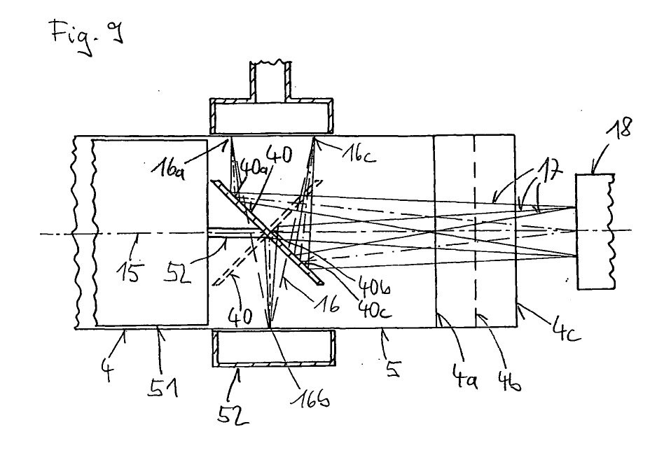

FIG. 8 shows an exemplary embodiment for which two rotating optical deflection elements 40 are arranged jointly with a radially outward deflecting optical element 33 inside a closed housing 47. The rotational bearing for the rotation of these optical elements 40, 33 around the section axis 15 is embodied as part of the laser scanning device 18. To position the radially deflecting optical element 33 and thus also the two deflection elements 40 so as to rotate around the section axis 15 and such that they can be displaced in the direction of the section axis 15, the laser scanning device 18 comprises an advancing device 34 with a guide 35 and a drive 36. During the severing, the advancing movement of the advancing device 34 must be synchronized precisely with the advancing movement of the pipe 4. A rotating device 37 is installed between the advancing part 38 and the radially deflecting optical element 33. For the embodiment shown, the radially deflecting optical element 33 comprises a mirror 33a and is connected via the housing 47 to the rotating part of the rotary device 37. A driving device 43 drives the housing 47 via a motion transmission 45. To make possible the housing movement in the direction of the section axis, the motion transmission 45 can comprise two pinions 45a, which can be displaced relative to each other in axial direction, of which one pinion is connected to the drive shaft 45b and the other one to the housing 47.

In the region of the severing plane that continuously advances along with the pipe 4 being produced, an optical deflection element 40 moves around the section axis 15, so that the laser beam 17 is deflected via this rotating optical deflection element 40 transverse to the section axis 15 onto the severing line 16. The rotating optical deflection element 40 is preferably embodied as flat mirror surface, if applicable as a prism such as a pentaprism. The focal region of a segment 17a of the laser beam 17 which is directed toward the pipe 4 is located at the start of the severing operation, at the starting location 16a of the severing line 16 while at the end of the severing operation it is located at the end location 16c.

The laser scanning device 18 with its outward deflecting optical element 33 generates a radially outward pointing laser beam segment 17c that rotates around the section axis 15. This rotating, radially outward deflecting optical element 33 can be embodied with a mirror of, if applicable, with at least one prism such as a pentaprism. From the laser source 18a, a laser beam segment 17b extends along the section axis 15 to the radially deflecting optical element 33 and from there via the two deflection elements 40 to the pipe 4.

In the embodiment shown, the laser beam 17 is not focused when it exits the laser source 18a. It is understood that a focusing device 48, for example a lens, can be arranged at an optimum location inside the housing 47 and that the beam between the laser source 18a and the focusing lens is then shaped as a parallel beam that is subsequently focused. With the embodiment shown herein, the length of the laser beam 17 from the focusing device up to the severing line 16 does not change, so that no adjustment of the focus position is required.

The exposed fronts 4a, 4b and 4c of the pipe 4 being produced are shown in three positions, namely at the start 4a, the center 4b and the end 4c of the severing operation. Once the pipe section 5 is severed completely, it can be removed in downward direction, during a part of the rotation where the housing 47 is not located below the pipe section.

In the housing 47, gas can be supplied to the severing region for blowing material that is generated during the laser severing from the severing joint. The gas reaches the inside of the housing 47, for example via a feed line 49 in the region of the laser source 18a. For the targeted orientation of the gas flow to the severing location, an exit nozzle 50 is installed on the housing.

FIG. 9 shows an embodiment for which the rotary-positioned optical deflection element 40 is arranged inside the pipe 4, in the region of the severing plane that continuously advances along with the pipe 4 being produced. The rotary drive is located in an internal part 51 and stimulates the movement of the deflection element 40 via a shaft 52. The laser beam 17 supplied by the laser scanning device 18 is beamed during at least one rotation onto the continuously rotating deflecting element 40. To ensure that the laser beam 17, which is deflected transverse to the section axis 15 toward the outside, is deflected at the start of the severing operation to the starting location 16a, in the center of the severing operation to the center location 16b and at the end to the ending location 16c of the severing line 16, the orientation of the beam emanating from the laser scanning device 18 must be changed, synchronized with the rotation of the deflection element 40, so that the deflection for the locations 16a, 16b and 16c occurs at the regions 40a, 40b, and 40c. For this, the laser scanning device 18 must not only rotate the beam 17 around the section axis 15, but must also realize a super-imposed movement in the direction radial to the section axis. The beam focus required for the severing line is adjusted by the laser-scanning device, respectively corresponding to the changing length of the laser beam 17.

To make it easier to remove the molten material, a low pressure can be generated, if applicable, in the region of the severing line 16 with the aid of a suction device 52 that is arranged in the manner of a collar around the pipe section 5. Between the suction device 52 and the laser scanning device 18, a clearance space is formed through which the pipe section 5 can be removed in a direction radial to the section axis 15.

It is understood that elements described with the aid of one embodiment can also be used advantageously in a different embodiment. For example, the removal device described with the aid of FIG. 5 can be used advantageously for each of the embodiments. It is understood that a focusing device adjusts the beam focus required at the severing line corresponding to the changing length of the laser beam that extends from the focusing device to the severing line.

What is claimed is:

1. A method for producing pipe sections, said method comprising:
continuously advancing band-shaped flat material with an advancing speed;
reshaping the material transverse to an axis of the band into a closed form; and
forming the material into a pipe by welding a longitudinal seam;
severing the pipe and producing the pipe sections at a free end of the pipe, wherein a pipe section to be severed extends over a sectional length along a section axis and wherein during the severing, a closed severing line is formed around the section axis in a circumferential direction of the pipe and wherein the severing line is located in a severing plane which is advanced continuously along with the pipe being formed and is located at a distance equal to a sectional length to the free end of the pipe, wherein in order to sever a pipe section, a laser beam supplied by a laser scanning device is conducted at least once along a complete circumference of the pipe being formed and, in the process, is directed with the aid of an optical element and transverse to the section axis onto the severing line, and wherein an essentially focused contact region of the laser beam on the pipe being formed is guided in the severing plane that continuously advances along with the pipe being formed completely along the closed severing line and in the process severs the pipe section from the pipe.

2. The method according to claim 1, wherein the laser beam is guided at least once along the complete circumference of a first optical element, which extends annular and closed around the section axis, and wherein the laser beam is directed along the complete circumference of the first annular, closed optical element in a direction transverse to the section axis onto the severing line.

3. The method according to claim 2, wherein a pipe section to be severed has a circular cross section extending around the section axis, wherein the first annular closed optical element extends circularly around the section axis and includes a surface which extends in longitudinal planes through the section axis, at an angle to the section axis, and wherein the laser scanning device is directed essentially in the direction of the section axis toward the pipe, wherein the focusing effect of the first annular, closed optical element and the focal shape of the laser beam arriving on the first optical element ensure the focus required for the severing in the contact region and that an angle of less than 45° is formed between the severing planes and the axis of the beam segment which impinges on the pipe.

4. The method according to claim 2, wherein the laser scanning device is arranged locally fixed and wherein during the severing operation, the orientation of the laser beam onto the continuously advancing severing line is achieved by changing the position of the laser beam in the section directly in front of the first annular, closed optical element, relative to the section axis, during the movement of the laser beam along the circumference of the first annular, closed optical element, wherein the position of the laser beam is aligned with the deflection characteristic of the first optical deflecting element which depends on the radial position where the laser beam impinges on the first annular, closed optical element, the location where the beam impinges along the circumference of the first annular, closed optical element and the advancing speed of the pipe, and wherein the focusing toward the location on the severing line where the laser beam impinges is continuously ensured.

5. The method according to claim 2, wherein the first annular, closed optical element is arranged around the pipe and wherein the laser beam is directed from the outside of the pipe toward the severing line.

6. The method according to claim 2, wherein the first annular, closed optical element is arranged inside of the pipe and wherein the laser beam is directed from the inside of the pipe toward the severing line.

7. The method according to claim 2, wherein the laser scanning device comprises an optical element to deflects transverse to the section axis toward the outside and is positioned rotating around the section axis and from which the laser beam is directed at an adjustable distance to the section axis essentially parallel to the section axis toward the first annular, closed optical element and wherein with a parallel displacement relative to the section axis of the laser beam segment, directed toward the first optical element, a desired movement is achieved of the laser beam that impinges on the pipe, thereby allowing the laser beam which impinges on the pipe to easily advance along with the advancing movement of the pipe.

8. The method according to claim 2, wherein a different annular, closed optical element is used and wherein a laser beam generated by the laser scanning device is guided at least once along the complete circumference of the first and the additional annular, closed optical element, wherein the laser beam is guided via the additional annular, closed optical element to the first annular, closed optical element.

9. The method according to claim 8, wherein the laser scanning device comprises a radially outward deflecting optical element, relative to the section axis, wherein the laser beam is directed by the radially outward deflecting optical element to the additional annular, closed optical element and from this element is then directed to the first annular, closed optical element, wherein the first and the additional annular, closed optical elements are embodied each as conical mirror with an opening angle of 45°, so that a radially outward directed laser beam impinging on the additional element is directed at the first optical element radially toward the inside onto the pipe and wherein, through a displacement of the radially outward directed laser beam in the direction of the section axis, a desired movement of the laser beam that radially impinges on the pipe obtained, such that it moves along with the pipe.

10. The method according to claim 2, wherein the laser scanning device is arranged locally fixed and wherein during the severing operation, the focusing of the laser beam onto the continuously advancing severing line is achieved in that the first annular, closed optical element moves along with the pipe during the severing operation.

11. The method according to claim 1, wherein at least one optical deflection element is positioned rotating around the section axis in the region where the severing plane is advanced continuously along with the pipe and wherein the laser beam is deflected transverse to the section axis onto the severing line, at least over partial regions of the rotating optical deflection element.

12. The method according to claim 11, wherein the at least one optical deflection element, positioned rotating, is moved back and forth in the direction of the section axis in the severing plane that continuously advances along with the pipe, or wherein the laser beam that impinges on the deflection element executes a combination movement with shares in circumferential direction and in radial direction to the section axis.

13. An apparatus for producing pipe sections, said apparatus comprising:
device to continuously advance band-shaped flat material;
a device to reshape the band-shaped flat material transverse to the band axis into a closed shape;
a device to weld a longitudinal seam along a pipe; and
a device to sever the pipe and produce a pipe section at a free end of the pipe, wherein the pipe section extends over a sectional length along a section axis, wherein during the severing operation a closed severing line is formed around the section axis along the pipe circumference and the severing line is positioned in a severing plane which advances continuously along with the pipe and is distanced by a section length from the pipe end, wherein the device to sever the pipe and produce a pipe section comprises a laser scanning device, wherein the laser scanning device causes a laser beam to be conducted at least once along the complete circumference of the pipe and directs this beam transverse to the section axis onto the severing line, thus making it possible for an essentially focused contact region of the laser beam on the pipe to be guided completely along the closed severing line in the severing plane which advances continuously along with the pipe.

14. The apparatus according to claim 13, wherein the device to sever the pipe and produce a pipe section comprises a first annular, closed optical element around the section axis, wherein the laser scanning device guides a laser beam at least once along the complete circumference of the first optical element and wherein the first optical element is embodied such that the laser beam is always directed transverse to the section axis onto the severing line, over the complete circumference of the first annular, closed optical element.

15. The apparatus according to claim 14, wherein the first annular, closed optical element extends circular around the section axis and includes a conical or concave surface that extends in the longitudinal planes through the section axis, at an angle to the section axis, and wherein the laser scanning device is oriented essentially in the direction of the section axis toward the pipe being produced, wherein the focusing effect of the first annular, closed optical element and the laser scanning device ensures a focus shape of the laser beam directed toward the first optical element which corresponds to the focus required in the contact region for the severing operation and wherein an angle is formed between the severing plane and the axis of the beam segment that impinges on the pipe which is less than 45°.

16. The apparatus according to claim 14, wherein the laser scanning device is arranged locally fixed and that during the severing operation, the orientation of the laser beam toward the continuously advancing severing line is ensured by changing the position of the laser beam in the section directly in front of the first annular, closed optical element, relative to the section axis, during the movement of the laser beam along the circumference of the first annular, closed optical element, wherein the position of the laser beam is coordinated with the deflection characteristic of the first optical element which depends on the location at which the laser beam impinges on the first annular, closed optical element, the position where it impinges along the circumference of the first annular, closed optical element and the advancing speed of the pipe, and wherein the focusing onto the location on the severing line where the laser beam impinges is ensured continuously.

17. The apparatus according to claim 14, wherein the first annular, closed optical element is arranged around the pipe and that the laser beam is directed from the outside of the pipe toward the severing line.

18. The apparatus according to claim 14, wherein the first annular, closed optical element is arranged on the inside of the pipe and wherein the laser beam is directed from the inside of the pipe toward the severing line.

19. The apparatus according to claim 13, wherein at least one optical deflection element is positioned rotating around the section axis in the region of the severing plane that advances continuously along with the pipe and wherein the laser beam is deflected at least over partial regions of this rotating optical deflection element in a direction transverse to the section axis onto the severing line, wherein the rotating optical deflection element is embodied as a planar mirror surface, if applicable as focusing deflection element.

20. The apparatus according to claim 19, wherein the at least one optical deflection element which is positioned rotating is movable back and forth in the direction of the section axis in the region of the severing plane that continuously advances along with the pipe, or that the laser beam which impinges on the deflection element allows realizing a combined movement with shares in circumferential direction and in radial direction to the section axis.

21. A pipe section with a longitudinal seam, wherein the pipe section is severed from a continuously produced pipe, wherein for the production of the pipe section band-shaped flat material is continuously advanced with an advancing movement, is reshaped into a closed form transverse to the band axis and by welding a longitudinal seam is formed into a pipe to be produced from which pipe sections are severed at the exposed end, wherein a pipe section to be severed extends over a sectional length along a section axis, wherein during the severing operation a closed severing line is formed around the section axis along the pipe circumference and the severing line is positioned in a severing plane that is advanced continuously along with the pipe being produced and is spaced apart from the exposed pipe end by one section length, wherein a laser beam, generated by the laser scanning device for severing the pipe section, is guided at least once along the complete circumference of the pipe being produced, so that an essentially focused contact region of the laser beam for the pipe being produced is guided along the closed severing line and, in the process, the pipe section is severed from the pipe being produced.

22. The method according to claim 3, wherein the surface which extends in longitudinal planes through the section axis is a conical or concave surface.

23. The method according to claim 11, wherein a flat mirror surface, if applicable a focusing deflection element, is used as rotating optical deflection element.
